(19) United States
(12) Patent Application Publication
(10) Pub. No.: US 2013/0074399 A1
(43) Pub. Date: Mar. 28, 2013

(54) CLOSED-LOOP ENERGY NEUTRAL AIR DRYING SYSTEM

(71) Applicant: GEURT REINDERS, Almelo (NL)

(72) Inventor: GEURT REINDERS, Almelo (NL)

(73) Assignee: HOUWELING NURSERIES OXNARD, INC.

(21) Appl. No.: 13/315,193

(22) Filed: Dec. 8, 2011

Related U.S. Application Data
(60) Provisional application No. 61/421,092, filed on Dec. 8, 2010.

(51) Int. Cl. F28D 15/02; A01G 9/24

(52) U.S. Cl. CPC F28D 15/02; A01G 9/24
USPC 47/17; 165/168; 165/104.21

(57) ABSTRACT

Systems and methods for dehumidifying or drying air entering a greenhouse while it is being cooled are disclosed. Air to be cooled is drawn through a cooling medium, and the systems and methods make use of heat extracted from the hot air before entering the cooling mechanism for use in heating the cooled air exiting the cooling mechanism. This reinsertion of the extracted heat into the exiting air allows for humidity control while maintaining a lower temperature compared to the temperature of the air as it entered the cooling mechanism. Different embodiments according to the present invention comprise closed-loop, energy neutral air drying systems that do not utilize external energy or materials to dry the air. This provides an energy efficient air drying system that allows for greenhouse operation with reduced operating costs.

This application claims the benefit of U.S. Provisional Patent Application Ser. No. 61/421,092, to Reinders, filed on Dec. 8, 2011, and having the same title as the present application.

### BACKGROUND OF THE INVENTION

1. Field of the Invention

This invention relates to air drying systems and in particular a closed-loop energy neutral air drying system that can be used in conjunction with greenhouse air cooling systems.

2. Background of the Invention

Greenhouses have been used for hundreds of years to grow different varieties of plants, including ornamental plants and fruit/vegetable producing plants. Greenhouses typically comprise a structure with a plastic or glass roof and frequently glass or plastic walls. The closed environment of a greenhouse has its own unique requirements compared with outdoor production. Pests and diseases need to be controlled and irrigation is necessary to provide water. Of equal importance, greenhouses can also be arranged to compensate for extreme highs and lows of heat and humidity, and to generally control the environmental conditions such as the level of carbon dioxide (CO₂).

Different greenhouses have been developed to control the environmental conditions in a greenhouse. U.S. Pat. No. 5,001,859 to Sprung describes a method and structure for environmental control of plant growth in greenhouse conditions. The structure comprises a translucent stressed fabric shell on a base, with which to grow plants, the shell and base sealing the environment within the space against external environmental conditions. The temperature and relative humidity within the production areas are generally controlled by a microprocessor based series of spray systems, along with a furnace. The spray systems can lower the temperature in the space while at the same time increasing humidity, and the furnace can be utilized to increase the temperature within the space.

U.S. Pat. No. 5,813,168 to Clendening describes a greenhouse and a method for controlling the environment of the interior space of the greenhouse. The greenhouse includes an interior insulating panel and a movable exterior reflective panel capable of both insulating the interior of the greenhouse and reflecting sunlight into the interior. The greenhouse also includes a closed-system heat exchanger having a plurality of spaced water-impermeable water flow passageways through which water flows by gravitational forces and having a means for blowing air between the water flow passageways such that the air does not contact the water and such that the air is either heated or cooled by the water. In addition, the heat exchanger may include a water discharge and/or a gas discharge for the control of humidity and gas levels within the greenhouse. Finally, the greenhouse includes hydroponic plant beds disposed on top of the heat exchangers and hydroponic solution tanks along the outer interior walls of the greenhouse.

U.S. Pat. No. 5,212,903 to Talbot discloses a greenhouse for providing environmental control for growing plants comprising a frame defining a structure forming an interior region for holding plants. A flexible cover is positioned over the frame for providing a roof enclosure for the structure, and an elongate roller extends along the length of the structure secured to a lengthwise edge of the cover. A power source is coupled to the roller driving the roller about its longitudinal axis to retract or extend the cover relative to the frame. The greenhouse also includes a water distribution system that includes a distribution conduit with spaced-apart spray nozzles positioned adjacent to the top interior of the greenhouse. A power drive system oscillates the conduit through a defined arc to distribute water downwardly to plants growing in the greenhouse. A timing means is associated with the power drive for delaying the return rotation of the conduit to ensure that the outside edges of the spray pattern will be watered evenly.

U.S. Pat. No. 7,228,657 to Brault et al. discloses a greenhouse having an exterior curtain wall structure formed by spaced tubular posts carrying external transparent panels and bottom non-transparent wall panels below a sill with the panels spanning the posts. A plurality of elongate benches is located within the interior at spaced positions along one side wall with the width of the benches being equal to the post spacing to form an expandable construction. Each bench has associated with it a respective air handling system for conditioning including a duct which is located partly under the respective bench and a fan in a fan housing at the side wall. From the fan a vertical duct section extends to a flexible tube extending over the bench. Air dehumidification, fogging, heating and cooling are provided in the duct under the bench. An alley is arranged along the opposite wall containing electrical controls mounted in cabinets forming panels for mounting in the span between posts.

European Patent Application No. EP 1 464 218 A1 discloses a method for growing crops arranged in a greenhouse that is closed off from the environment and wherein the climate is regulated and watering of the crop is controlled within by a watering device. The photosynthesis and yield of the crop is regulated by controlling, independent of the outside conditions, the CO₂ concentration in the greenhouse and the transpiration by regulation of the temperature and air movements around the crop. Air regulating means can be utilized such as partitions, screens and the like, and outlet openings for air at different heights near the crop are provided so that the climate near the crop, and in particular the microclimate near the leaves of the crop, can be regulated and monitored.

International Application No. PCT/NL2000/000402 (Publication No. WO 2000/076296) discloses a market garden greenhouse system in which plant products can be cultivated. The market greenhouse is closed in that it is substantially not provided with ventilating openings or ventilating windows that can be opened. The greenhouse comprises heat regulating means for regulating heat therein, with heat generating from solar energy and a heating system. The greenhouse can also comprise an air humidity regulator wherein surplus heat is removed from the greenhouse to an aquifer in the summer.

One concern with conventional greenhouse cooling systems is how to efficiently control the humidity of the cooled air entering the greenhouse. As air passes through a conventional cooling mechanism and is cooled, its humidity will typically rise. This can result in very humid air entering the greenhouse, particularly in high humidity environments. There are systems available to reduce the humidity of the air after it is cooled, but these systems can require the use of energy such as from an external heat source. This need for additional energy to dehumidify or dry air entering the greenhouse can reduce the overall energy efficiency of the greenhouse and can result in increased operating costs.

### SUMMARY OF THE INVENTION

The present invention comprises efficient systems and methods for dehumidifying or drying the air entering a greenhouse while it is being cooled. Air to be cooled is drawn through a cooling medium, and the systems according to the present invention make use of heat extracted from the hot air before entering the cooling mechanism for use in heating the cooled air exiting the cooling mechanism. This reinsertion of the extracted heat into the exiting air allows for humidity control while maintaining a lower temperature at which the air entered the mechanism. By reallocating the energy and circumnavigating the cooling medium, the medium remains uninfluenced and performs to its own specifications. Different embodiments according to the present invention comprise closed-loop, energy neutral air drying systems that do not utilize external energy or materials to dry the air. This provides an energy efficient air drying system that allows for greenhouse operation with reduced operating costs.

One embodiment of a closed loop dehumidifying system according to the present invention comprises an air passage and a mechanism for changing the temperature of the air passing through the air passage. A heat exchanger is included to transfer heat generated during the changing of the temperature, to the air exiting the air passage to dehumidify the exiting air.

One embodiment of a greenhouse according to the present invention comprises a growing section and a climate control system adjacent to the growing section allowing air to flow into the growing section and comprising a mechanism for changing the temperature of the air passing into the growing section. A heat exchanger is included and arranged to cooperate with the climate control system to transfer heat generated during the changing of the temperature, to the air exiting the climate control system to dehumidify the exiting air.

One embodiment of a method for dehumidifying cooled air according to the present invention comprises removing heat from air source to cool the air and conducting said heat from the air source to different location. The heat is then applied to the cooled air at the different location to at least partially dehumidify the cooled air.

These and other aspects and advantages of the invention will become apparent from the following detailed description and the accompanying drawings which illustrate by way of example the features of the invention.

### BRIEF DESCRIPTION OF THE DRAWINGS

FIG. 1 is a schematic on one embodiment of an air drying system according to the present invention;

FIG. 2 is a schematic of an air drying system according to the present invention;

FIG. 3 is a schematic of an air drying system according to the present invention used with air distribution hoses;

FIG. 4 is a schematic of another air distribution system according to the present invention used in the air heating mode with an air distribution hose; and

FIG. 5 is one embodiment of a greenhouse according to the present invention.

### DETAILED DESCRIPTION OF THE INVENTION

The present invention generally relates to improved greenhouses and greenhouse climate control systems. In particular the present invention relates to efficient systems and methods for controlling the humidity of air entering a greenhouse after it is cooled. Different embodiments can be closed-loop and energy neutral to allow for efficient and cost effective greenhouse operation.

Some embodiments according to the present invention operate by working in conjunction with a greenhouse cooling medium. As the warm (and humid) air to be cooled is drawn into the cooling medium, heat from the air is captured. As the air is cooled, its humidity typically increases and in some high humidity environments the air leaving the cooling medium and entering the greenhouse can have up to 100% humidity. To reduce this humidity, heat that was captured from the air entering the cooling medium is transferred to the output of the cooling medium and used to heat the air leaving the cooling medium before or at the same time that it enters the greenhouse. This heating slightly increases the temperature of the air entering the greenhouse, but provides the advantage of a decrease in the humidity of the air.

Different arrangements can be used to capture heat at the cooling medium inlet for use at the cooling medium outlet. In some embodiments, a closed loop system can be used where the heat is captured at the cooling medium input and without the use of external mechanisms or energy, the heat is transmitted or conducted to a location where it can heat the air leaving the cooling medium and entering the greenhouse. One closed loop embodiment can comprise many different mechanisms for conducting heat can be used and in some embodiments can comprise a series of heat pipes surrounding the cooling medium.

Heat pipes are generally known in the art and are only briefly discussed herein. Heat pipes can comprise a heat-transfer device that combines the principles of both thermal conductivity and phase transition to efficiently manage the transfer of heat between two interfaces. At the hot interface (i.e. interface where heat captured from the air entering the cooling medium) of the heat pipe, a liquid in contact with a thermally conductive solid surface turns into a vapor by absorbing heat from that surface. The vapor condenses back into a liquid at the cold interface, releasing the latent heat. The liquid then returns to the hot interface through either capillary action or gravity action where it evaporates once more and repeats the cycle. In addition, the internal pressure of the heat pipe can be set or adjusted to facilitate the phase change depending on the demands of the working conditions of the thermally managed system.

A typical heat pipe consists of a sealed pipe or tube made of a material with high thermal conductivity such as copper or aluminium at both hot and cold ends. A vacuum pump can be used to remove all air from the empty heat pipe, and then the pipe is filled with a fraction of a percent by volume of working fluid, substance, or coolant chosen to match the operating temperature. Examples of such fluids include water, ethanol, acetone, sodium, or mercury. Due to the partial vacuum that is near or below the vapor pressure of the fluid, some of the fluid will be in the liquid phase and some will be in the gas phase.

When the hot air is drawn into the cooling medium it passes by the heat pipes and heats the substance within the heat pipe. This heat causes the substance to heat and pass through the pipes to a location where the humid cooled air from the cooling medium passes over the pipes. Heat from the substance conducts to the air causing the cooled air to heat up. At the same time, this heat transfer causes the substance to cool thereby altering its density, causing it to pass through the pipes to a location where the substance can again be heated by air being drawn into the cooling medium. This closed loop operation requires no external energy, and can continuously operate without the need for external heat or energy.

The present invention is described herein with reference to certain embodiments but it is understood that the invention can be embodied in many different ways and should not be construed as limited to the embodiments set forth herein. In particular, the present invention is described below in regards to heat exchangers and cooling mediums arranged in particular ways, but it is understood that these features can be arranged in different ways and can be used in other applications. The present invention is also described below as using a heat pipe arrangement for its heat exchanger, but it is understood that many different heat exchanges can be used that can be arranged in many different ways.

It is also understood that when an element or feature is referred to as being “on” or “adjacent” another element or feature, it can be directly on or adjacent the other element or feature or intervening elements or features may also be present. Furthermore, relative terms such as “above”, “lower”, “below”, and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. The heat exchanger is described herein with using a number of different terms such as heat pipes, heat exchangers, and exchange pipes, but it is understood that theses terms are meant to include heat pipes as described above, as well as many other heat management mechanisms.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

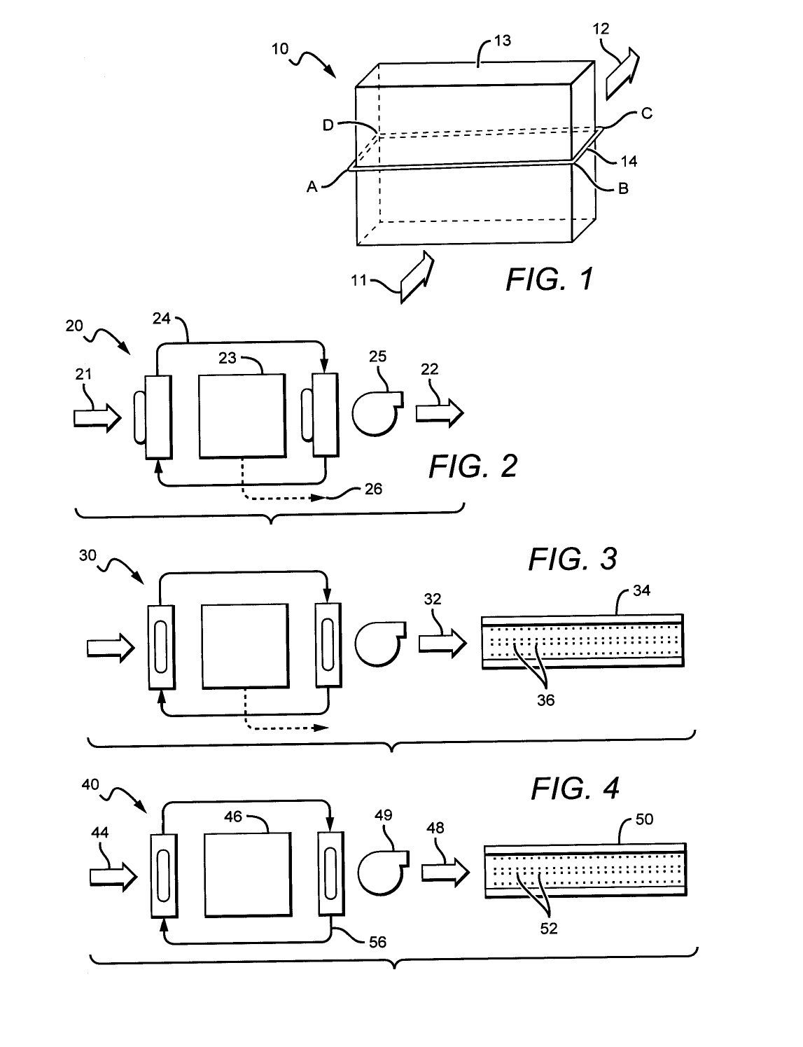

FIG. 1 shows one embodiment of an air drying system 10 according to the present invention that is particularly applicable to cooling air for use in a greenhouse. FIG. 1 shows an air inlet stream 11 entering the cooling medium 13, with the inlet stream 11 comprising air from outside the greenhouse. In greenhouse systems arranged to recirculate air from inside the greenhouse back through the cooling medium, the air inlet stream can comprise air from within the greenhouse as well as air from outside the greenhouse. FIG. 1 also shows an air outlet stream 12 leaving from the cooling medium and entering the greenhouse. As discussed above, the cooling of the air stream 11 in the cooling medium 13 can result in elevated humidity levels in the outlet stream 12 entering the greenhouse, an in some high humidity environments this can reach up to 100% humidity. The present invention is arranged to reduce this elevated humidity.

The cooling medium 13 can comprise any conventional cold exchanger or heat exchanger that contains energy to be transmitted to the air passing through the cooling medium. According to the present invention, depicted in FIG. 1, heat pipes 14 are arranged around the cooling medium 13, and although only one pipe is shown in FIG. 1 with 4 steps, it is understood that the present invention can comprise a plurality of exchange pipes and steps, each of which can comprise its own loop around the cooling medium 13. In some embodiments the heat pipes can be in direct contact with the cooling medium 13, while in other embodiments the heat pipes can be adjacent to, but in thermal contact or communication with, the cooling medium 13.

The some embodiments there can be up to 20 exchange pipes, while in other embodiments there can be more than 20 exchange pipes. The number of exchange pipes can depend on a number of different factors such as the size of the cooling medium, the size of the exchange pipes, and the extent to which the outlet stream 2 is to be cooled.

The exchange pipes 14 can be arranged in many different ways and in multiple steps, but in the embodiment shown are arranged to illustrate basic two separate cold/heat exchangers. The two heat exchanger comprise first and second pipe sections A-B and C-D, which are connected by sections B-C and D-A of exchange pipes 14 to form a loop around the cooling medium 13. The first section A-B is located at the air inlet of the cooling medium 13, such that the inlet stream 11 passes by and in thermal contact with the first section A-B. The second section C-D is located at the outlet of the cooling medium such that the outlet stream 12 passes by and in thermal contact with the second section C-D. In the embodiment shown, the surfaces of the exchange pipes 14 are not in physical contact with the cooling medium 13, but other embodiments can be arranged in many different ways.

In some embodiments, the exchange pipes 14 are sloped to provide the closed loop operation such that A is at a height lower than B, B is at a height lower that C, D is at height lower than C, and A is at a height lower than D. In this arrangement, C is the highest point and A is the lowest point of the exchange pipes. It is understood that the sections of the heat exchange pipes 14 can be sloped to many different ways and at many angles depending on a number of factors such as the size of the cooling medium 13, size of the exchange pipes 14, type of substance in the exchange pipes 14, etc. In one embodiment having a cooling medium approximately 4 feet wide, the exchange pipes can be angled arranged around the cooling medium such that B is two inches higher than A, C is one inch higher that B, D is two inches lower than C, and A is one inch lower than D. Again, this is only one example of the many different height differences that can be part of different embodiments according to the present invention.

The exchange pipes 14 can comprise any material that conducts heat and capable of being formed such that it transfers the thermal energy. In case of a heat pipe, the pipe material must be such that heat can be exchanged between the substance within the pipes as described above, and the surrounding ambient, and vice-verse. The exchange pipes 14 can contain a substance that can pass between the different sections of the pipes. Many different substances can be used and in some embodiments the substance can comprise a liquid coolant as described above.

In operation, the air inlet stream 11 enters the air cooling medium 13, and in some embodiments the inlet stream can comprise hot humid air. Heat from the hot humid inlet stream thermally contacts the exchange pipes 14 in the first section A-B and heat passes through the exchange pipes 14 to the substance in the first section A-B. This causes the substance in the first section A-B to expand and reduce in density because of the added heat. This causes the heated substance to rise in the sloped section A-B, and the substance begins to flow up sloped section B-C of the exchange pipes 14. This flow continues to the second heat exchange section C-D.

The air leaving the cooling medium 3 as the outlet stream 12 will be colder than the air entering the cooling medium as inlet stream 11. The outlet stream 12 has at least an equal to or higher humidity than air in the inlet stream 11. The outlet stream can comprise a cold humid air flow that comes in contact with the exchange pipes 14 at the second section C-D. Heat from the substance in the second section C-D will be conducted to the cool humid stream in the outlet stream 12. This will result in a slight warming of the outlet stream, with a corresponding reduction in the humidity of the outlet stream 12. In some embodiments, the stream leaving section C-D can be warmed in the range of 0 to 5° C., compared to air entering section C-D. In other embodiments it can be warmed in the range of to 10° C., while in still other embodiments it can be warmed in the range of 0 to 15° C.

The temperature of the outlet stream 12 after passing over the second section C-D will be lower than the inlet stream 11 entering the air cooling medium, but it will have an acceptable humidity level. In one embodiment, the outlet stream leaving the cooling medium 13 can have a humidity of approximately 100%, and the outlet stream after passing over the second section C-D can have a humidity of less than 100%. In some embodiments the outlet stream 12 after passing over the second section C-D can have a humidity of less than 90%, while in other embodiments, the outlet stream 12 can have a humidity of less than 80%.

In this process heat from the substance in second section C-D is conducted to the outlet stream 12, which in turn causes the substance to cool and become denser. This causes the substance to flow naturally back to the first heat exchange section A-B by the natural flow along section D-A. The cooled substance will again be in the first heat exchange section A-B where the process can start again by the inlet stream heating the substance in the first section A-B.

This closed-loop, energy neutral process in the exchange pipes from points A to B, B to C, C to D and back from D to A will continuously work as long as the air inlet stream 11 entering the cooling medium 13, is hotter than the temperature of the cooling medium 13.

FIG. 2 shows another schematic of the air flow of one embodiment of a distribution (dehumidifying) system 20 according to the present invention. An air inlet stream 21 is drawn into the cooling medium 23, and many different devices can be used to draw the air inlet stream, with one embodiment utilizing a fan motor 25. As the air enters the cooling medium 23 it passes over the exchange pipes 24 and heats the substance as described above. The chemical process as described above begins in the substance within the exchange pipes 24 and begins the closed-loop process described above. After the inlet stream is cooled in the cooling medium, it passes over the heated substance in the exchange pipes. The air stream is warmed and dehumidified before it passes into the greenhouse as outlet stream 22. The cooling medium can also produce liquid condensates 26 as it cools the inlet stream.

FIG. 3 shows another embodiment of the air flow of another embodiment of a distribution (dehumidifying) system according to the present invention similar to the system shown in FIG. 2, but wherein the outlet stream 32 enters an air distribution hose or tube 34 that is arranged within a greenhouse. The outlet stream 32 enters the hose or tube 34, with the tube having a series of holes 36 along its length. In one embodiment, the holes are arranged such that air from the tube 36 exits into the greenhouse in a manner that provides for near uniform distribution of air within the greenhouse. Different tube arrangement are described in U.S. Patent Application Publication No. 2010/0126062, titled “Greenhouse and Forced Greenhouse Climate Control System and Method,” filed on Dec. 11, 2009, and incorporated herein by reference.

FIG. 4 shows another embodiment of an air distribution system 40 shown in FIG. 3, but instead of cooling air, the system is arranged to heat the air. The air inlet stream 44 passing into the medium 46 that is now in a mode that heats the air. The outlet stream 48 has a temperature that is higher than the inlet stream 44. A fan 49 distributes the heated outlet stream to hose or tube 50 where it is distributed to the greenhouse through holes 52. Because the temperature of the inlet stream 44 is lower than that of the outlet stream 48, there is no flow of the substance in exchange pipes 56, and the exchange pipes 56 have no impact on the humidity of the outlet stream.

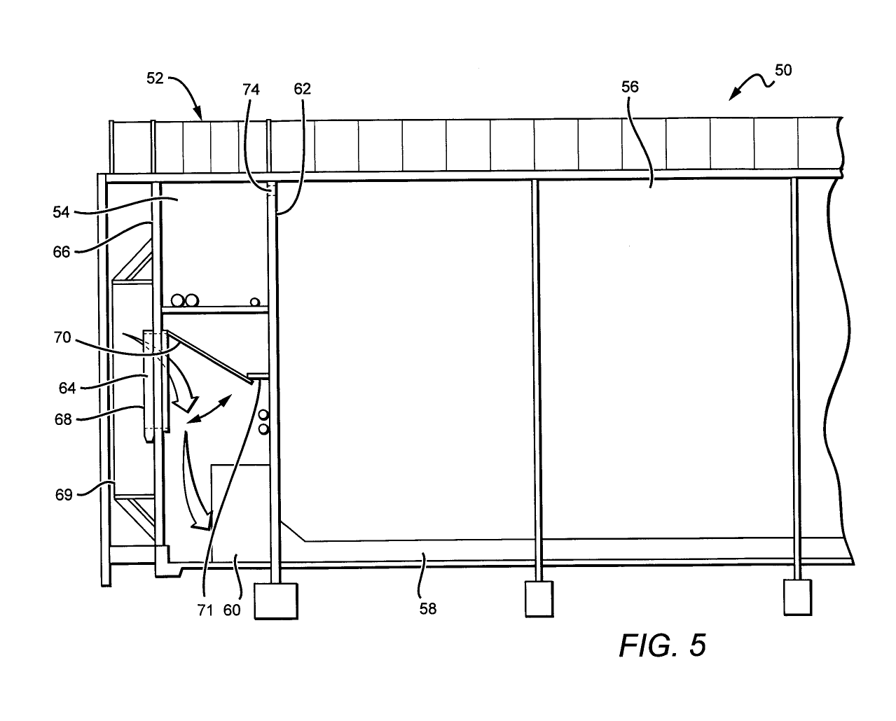

The distribution (dehumidifying) system embodiments according to the present invention can be used with many different greenhouse arrangement, with some examples being those greenhouses described in U.S. Patent Application Publication No. 2008/0000151, titled “Greenhouse and Forced Greenhouse Climate Control System and Method,” filed on Jun. 28, 2007, and incorporated herein by reference. FIG. 5 shows one embodiment of greenhouse 50 can utilize a distribution (dehumidifying) system according to the present invention. The greenhouse 50 utilizes a forced greenhouse climate control system 52 and has a gabled end that is separated from the crop holding section 56 of the greenhouse 50 by partition 62. The crop section 56 comprises an air distributing device to distribute air from the gabled end 54 throughout the crop section 56. Many different distribution devices can be used, with a suitable device being a plurality of tubes 58 running the length of the crop section 56. The tubes 58 can open through the partition 62 such that air from the gabled end 54 can flow into the tubes 58.

Fans 60 can placed in or close to the partition 62 between. Each of the tubes 58 are connected to an opening in the partition lower portion of the partition 62. A respective fan 60 is then arranged over each of the openings and air from each of the fans 60 flows into its respective one of the tubes 58. The fans 60 are arranged with the ability to pull ambient air from in the gabled end into the tubes during operation. This can either be ambient air or re-circulated air, or combination of the two.

The greenhouse 50 further comprises a vent/opening (“vent”) in the outside gable wall 66 through which ambient air can enter the gabled end 54. The vent 64 can be in different locations, but in the embodiment shown is located near the center of the gabled wall 66, as shown. The vent 64 preferably runs the length of the gabled wall and although one vent 64 is shown it is understood that more than one opening can be included.

A cooling mechanism 68 can also be included at the vent 64 to cool air being pulled in into the gabled end 54, and/or to control the humidity within the air. In one embodiment the cooling mechanism 68 is a conventional pad cooling system that also runs the length of and is included over the vent 64. A screen 69 can also be included over the vent 64 to prevent insects and other pests from entering the greenhouse 50. An air system 68 can also be included at or near the fans 60 to heat or cool air entering the tubes 58 as described above. An air distribution (dehumidifying) system according to the present invention can be arranged at the air system 68 to dehumidify air entering the greenhouse 50.

A first louver 70 can be included inside of gable wall 66 that is movable in the directions of arrows 73 to control the amount of ambient air entering the end gable 54. When operating in the mode to block air from entering the end gable 54 the louver 70 is closed to cover the vent 64. When operating in the mode to allow air to enter the end gable 54, the louver 70 can be swing open so that it is not blocking air from entering or can be partially opened such that it is partially blocking air from entering. As the louver 70 swings from its closed and fully blocking position over the first vent/opening 64 it also blocks re-circulating air that would otherwise be pulled into the tubes 58 by the fans 60. The greenhouse further comprises a shelf 71 on the inside surface of the partition 62. When the louver 70 is fully opened its lower surface abuts the shelf 71 to fully block re-circulating air from being drawn by the fans 60. Instead, in this position the fans 60 draw primarily ambient air that can be cooled by cooling mechanism 68. It is understood that many different mechanisms can be used beyond the first louver 70 described above.

The partition 62 comprises a second vent/opening 74 that is located near the top of the partition 62, although the vent 74 can be in many different locations. Unlike the vent 34 described above in greenhouse 10, the vent 74 does not have a second louver and remains open through operation. The amount of air from the crop section 56 drawn through by the fans and re-circulated into the tubes is controlled by the extent to which the louver 70 is opened. If the louver 70 is fully closed all of the air drawn through the fans 60 comes through vent 74 for re-circulating. When the louver 70 is fully open no air through the vent is drawn by the fans. When the louver is at different positions between fully open and closed, the fans draw a combination of ambient and air through the vent 74.

The embodiments of the distribution (dehumidifying) systems according to the present invention are described herein with reference to use in greenhouses, but it is understood that this systems can be used in many different applications. These can include conventional food refrigeration units, commercial air conditioning units, residential air conditioning units, etc. Although the present invention has been described in detail with reference to certain preferred configurations thereof, other versions are possible. Therefore, the spirit and scope of the invention should not be limited to the versions described above.

I claim:

1. A closed loop dehumidifying system, comprising:
an air passage;
a mechanism for changing the temperature of the air passing through said air passage;
a heat exchanger to transfer heat generated during said changing of the temperature, to the air exiting said air passage to dehumidify said exiting air.

2. The system of claim 1, wherein said heat exchanger warms the air exiting said air passage.

3. The system of claim 1, wherein said mechanism for changing the temperature comprises an air cooler.

4. The system of claim 1, wherein said heat exchanger comprises one or more heat pipe.

5. The system of claim 1, arranged to dehumidify cooled air exiting from said passage.

6. A greenhouse, comprising:
a growing section;
a climate control system adjacent to said growing section allowing air to flow into said growing section and comprising a mechanism for changing the temperature of the air passing into said growing section; and
a heat exchanger arranged to cooperate with said climate control system to transfer heat generated during said changing of the temperature, to the air exiting said climate control system to dehumidify said exiting air.

7. The greenhouse of claim 6, wherein said heat exchanger warms the air exiting said climate control system.

8. The greenhouse of claim 6, wherein said mechanism for changing the temperature comprises an air cooler.

9. The greenhouse of claim 6, wherein said heat exchanger comprises one or more heat pipe.

10. The greenhouse of claim 6, arranged to dehumidify cooled air exiting from said passage.

11. The greenhouse of claim 6, wherein said climate control system controls the environment within said growing section.

12. The greenhouse of claim 11, wherein said climate control system is arranged to flow ambient air from outside said greenhouse into said growing section, re-circulate air from said growing section back into said growing section, or a combination thereof.

13. The greenhouse of claim 6, further comprising a plurality of tubes within said growing section, air entering said growing section from said climate control system passing into said tubes with said tubes distributing air throughout said growing section.

14. A method for dehumidifying cooled air, comprising:
removing heat from air source to cool the air;
conducting said heat from said air source to different location; and
applying said heat to said cooled air at said different location to at least partially dehumidify said air.

15. The method of claim 14, wherein said heat is conducted to said different location by a heat exchanger warms.

16. The method of claim 14, wherein said applying said heat results in heating of the said cooled air at said different location.

17. The method of claim 15, wherein said heat exchanger comprises one or more heat pipe.
